(19) United States
(12) Patent Application Publication
(10) Pub. No.: US 2011/0079409 A1
(43) Pub. Date: Apr. 7, 2011

(54) POWER TOOL

(75) Inventors: Kazuyuki Sakakibara, Anjo-shi (JP); Kiyozumi Kokawa, Anjo-shi (JP)

(73) Assignee: MAKITA CORPORATION, Anjo-shi (JP)

(21) Appl. No.: 12/961,984

(22) Filed: Dec. 7, 2010

Related U.S. Application Data
(63) Continuation of application No. 11/347,363, filed on Feb. 6, 2006, now abandoned.

(30) Foreign Application Priority Data
Feb. 10, 2005 (JP) 2005-035286

(51) Int. Cl. B25F 5/02

(52) U.S. Cl. 173/170

(57) ABSTRACT

It is an object of the invention to provide an effective technique for reducing the load of user's fingers in a power tool. A representative power tool includes a body, a tool bit, a driving means and a handgrip that extends from a grip proximal end on the side of the body to a grip distal end in a direction that crosses the axial direction of the tool bit. The power tool includes a holding optimization region that is arranged on the handgrip and shaped to match with the holding form of the fingers of the user when the user holds the handgrip. Specifically, the holding optimization region at least includes the rear end surface of the grip distal end region such that a normal on the rear end surface crosses an axis of the tool bit forward of the handgrip. As a result, according to the invention, the force of the user's fingers and palm on the handgrip can be optimized.

### BACKGROUND OF THE INVENTION

1. Field of the Invention

The present invention relates to a technique for constructing a power tool.

2. Description of the Related Art

Japanese non-examined laid-open Patent Publication No. 2002-254341 discloses a power tool in which a tool bit is driven by an electric motor. This power tool includes a body, a tool bit mounted to the tip end region of the body, an electric motor housed within the body to drive the tool bit, and a handgrip that extends from the grip proximal end on the side of the body to the grip distal end in a direction that crosses the axial direction of the tool bit. In various kinds of power tools of which handgrip is held by the user to perform an operation, a further improved technique for reducing the load of user's fingers is desired.

### SUMMARY OF THE INVENTION

Accordingly, it is an object of the invention to provide an effective technique for reducing the load of user's fingers in a power tool.

According to the present invention, a representative power tool may include a body, a tool bit mounted to a tip end region of the body, a driving mechanisms housed within the body to drive the tool bit, and a handgrip that extends from a grip proximal end on the side of the body to a grip distal end in a direction that crosses the axial direction of the tool bit. The “power tool” widely includes an electric, pneumatic or gas power tool and is used for tightening various kinds of screws, cutting, grinding, polishing, nailing, riveting, drilling or other similar operations. Further, the power tool includes a holding optimization region that is arranged on the handgrip and shaped to match with the holding form of the fingers of the user when the user holds the handgrip. According to the invention, with the configuration in which the handgrip is shaped to match as much as possible with the holding form of the fingers of the user when the user holds the handgrip, the force of the user's fingers on the handgrip can be optimized.

Typically, the holding optimization region may include at least one of first to fourth regions. The first region is configured on the rear end surface of the grip distal end region such that a normal on the rear end surface crosses an axis of the tool bit forward of the handgrip. The first region may be formed only on the grip distal end. Otherwise, a plurality of the first regions may be formed within a predetermined region between the grip distal end and the grip proximal end. The user can perform an operation while evenly pressing the handgrip to the side of the tip end of the tool via the first region. Thus, the handgrip configuration which offers less fatigue and causes less pain in the user's hand during operation can be realized.

The second region is configured on the trigger front surface such that a normal on the trigger front surface crosses an axis of the tool bit forward of the handgrip.

The third region is configured in the handgrip such that the handgrip has an oval section along the axial direction of the tool bit and such that the section has a maximum diameter portion of which both major axis and minor axis are maximum, while having a minimum diameter portion of which both major axis and minor axis are minimum. The maximum diameter portion may be disposed in a region of the handgrip between the grip proximal end and the grip distal end. On the other hand, the minimum diameter portion may be disposed nearer to the grip distal end than the maximum diameter portion. Thus, the major and minor axes are gradually reduced from the region between the grip proximal end and the grip distal end toward the grip distal end. The maximum diameter portion may be disposed in a region of the handgrip between the grip proximal end and the grip distal end, while the minimum diameter portion may be disposed nearer to the grip distal end than the maximum diameter portion. As a result, holding force of the entire palm can be effectively utilized when holding the handgrip.

The fourth region is configured in the handgrip such that a connecting line continuously and vertically connecting vertexes on a side surface of the handgrip may extend in the form of a letter S such that an upper end of the line is directed toward a rear end of the grip proximal end and a lower end of the line is directed toward a front end of the grip distal end. Thus, the vertexes (convex portions) of the grip side surface are snugly fitted into the hollow (concave portion) of the palm of the user who holds the handgrip. As a result, the force of the fingers of the user can be efficiently exerted on the handgrip.

Preferably, the connecting line continuously and vertically connecting vertexes on the side surface of the handgrip may extend substantially along a heart line or a head line of the palm of the user who holds the handgrip. This configuration is provided to conform to the hollow (concave portion) formed particularly along the heart line or the head line on the palm of the user when holding the handgrip. Other objects, features and advantages of the present invention will be readily understood after reading the following detailed description together with the accompanying drawings and the claims.

### BRIEF DESCRIPTION OF THE DRAWINGS

FIG. 1 is a side view showing an impact driver 100 according to an embodiment of the invention.

FIG. 2 is a rear view of the impact driver 100 shown in FIG. 1 and viewed from the right side in FIG. 1.

FIG. 3 shows a battery 140 of the impact driver 100 shown in FIG. 1 in the attached state and in the detached state.

FIG. 4 is a side view of a handgrip 130 in this embodiment.

FIG. 5 is a sectional view of the handgrip 130 taken along line A-A in FIG. 4

FIG. 6 is a sectional view of the handgrip 130 taken along line B-B in FIG. 4.

FIG. 7 is a sectional view of the handgrip 130 taken along line C-C in FIG. 4.

FIG. 8 is a sectional view of the handgrip 130 taken along line D-D in FIG. 4.

FIG. 9 is a sectional view of the handgrip 130 taken along line E-E in FIG. 4.

FIG. 10 schematically shows the surface configuration of the handgrip 130 of this embodiment.

FIG. 11 shows the form of the fingers and palm which are assumed to be holding the handgrip.

FIG. 12 shows the distribution of skin shearing stress on a web part as a result of the mechanical simulation analysis on the handgrip 130 of this embodiment and a comparative example.

### DETAILED DESCRIPTION OF THE INVENTION

Each of the additional features and method steps disclosed above and below may be utilized separately or in conjunction with other features and method steps to provide and manufacture improved power tools and method for using such power tools and devices utilized therein. Representative examples of the present invention, which examples utilized many of these additional features and method steps in conjunction, will now be described in detail with reference to the drawings. This detailed description is merely intended to teach a person skilled in the art further details for practicing preferred aspects of the present teachings and is not intended to limit the scope of the invention. Only the claims define the scope of the claimed invention. Therefore, combinations of features and steps disclosed within the following detailed description may not be necessary to practice the invention in the broadest sense, and are instead taught merely to particularly describe some representative examples of the invention, which detailed description will now be given with reference to the accompanying drawings.

A representative embodiment of the “power tool” of the present invention will now be described with reference to the drawings. In this embodiment, an electric (battery-powered) impact driver is described as an example of the power tool.

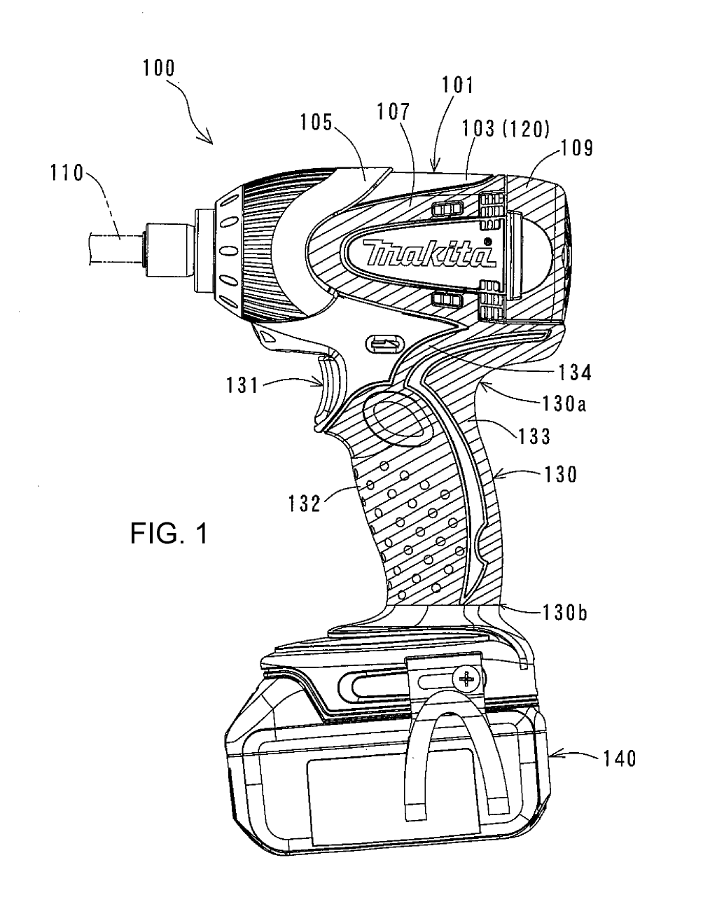

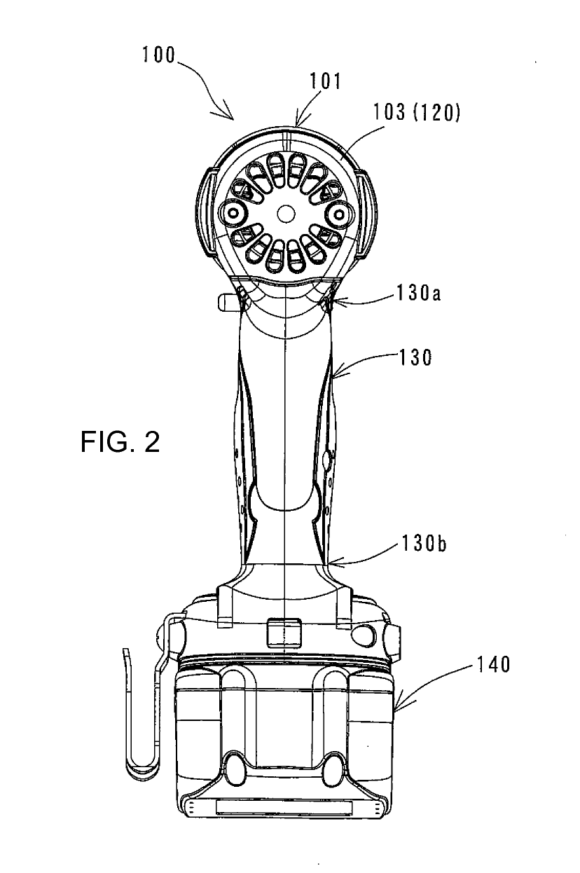

FIGS. 1 and 2 show an external view of an impact driver 100 according to the representative embodiment of the invention. FIG. 1 is a side view of the impact driver 100 and FIG. 2 is a rear view of the impact driver 100 shown in FIG. 1 and viewed from the right side in FIG. 1.

As shown in FIGS. 1 and 2, the impact driver 100 of this embodiment includes a body 101, a driver bit 110, a driving motor 120, a handgrip 130 and a battery 140. The driver bit 110 is removably mounted to the tip end region of the body 101 and performs an operation of tightening various screws. The driving motor 120 is housed within the body 101.

The body 101 includes a motor housing 103 and a gear housing 105. The body 101 forms the “body” according to the present invention. The body 101 may also be referred to as the “body” together with and the handgrip 130.

The motor housing 103 houses the electric driving motor 120. The driver bit 110 protrudes from the end of the gear housing 105 and is driven by the driving motor 120. The driving motor 120 is a feature that corresponds to the “electric motor” according to this invention. The driver bit 110 that is a driven element to be driven by the driving motor 120 is a feature that corresponds to the “tool bit mounted to the tip end region of the body” according to this invention.

Although particularly not shown, the gear housing 105 houses a speed reducing mechanism for appropriately reducing the speed of rotation of an output shaft of the driving motor 120, a spindle that is rotated by the speed reducing mechanism, a hammer that is rotated by the spindle via balls, and an anvil that is rotated by the hammer. The end of the anvil protrudes from the end of the gear housing 105. The driver bit 110 is detachably mounted into this protruded end of the anvil.

The handgrip 130 is a grip held by the user to perform an operation or to carry the power tool. When the user holds the power tool by hand, the holding force (grip) of the hand is exerted on the handgrip. The handgrip 130 of this embodiment extends from a grip proximal end 130a on the underside of the body 101 to a grip distal end 130b in a direction that crosses the axial direction of the driver bit 110. A trigger 133 for throwing a power switch (not shown) of the driving motor 120 is provided on the front portion of the handgrip 130. The trigger 133 is operated by the user to start and stop the driving motor 120.

Further, the body 101 has a casing made of hard material (hard synthetic resin material or other similar material). A cushion of soft material (soft synthetic resin material, rubber material or other similar material) softer than the hard material is further provided around the casing. The cushion is shown, for example, diagonally shaded in FIG. 1 and includes a side contact portion 107, a rear end contact portion 109, a grip front contact portion 132, a grip rear contact portion 133 and a connecting portion 134. The side contact portion 107 is formed on the both side surfaces of the body 101 and the rear end contact portion 109 is formed on the rear end surface of the body 101. The grip front contact portion 132 is formed on the front and side surfaces of the handgrip 130 and the rear end contact portion 109 is formed on the rear end surface of the body 101. The connecting portion 134 connects the side contact portion 107, the grip front contact portion 132 and the grip rear contact portion 133. By providing the cushion having such a construction, the impact driver can provide the user who holds the handgrip 130 for operation with a soft feel of grip and an impression of being novel in appearance.

The battery 140 is removably attached to the grip distal end portion (lower end portion) of the handgrip 130. The battery 140 has a plurality of cylindrical cells (rechargeable battery), which is not shown, as a power source for supplying current to the driving motor 120. The cells are housed within the housing and arranged in a horizontal position. Instead of this construction, one or more of cylindrical cells may also be arranged in an inverted vertical position within the housing. Further, various kinds of boards and wiring that connect the driving motor 120 to the battery 140 are housed within the accommodating space of the handgrip 130.

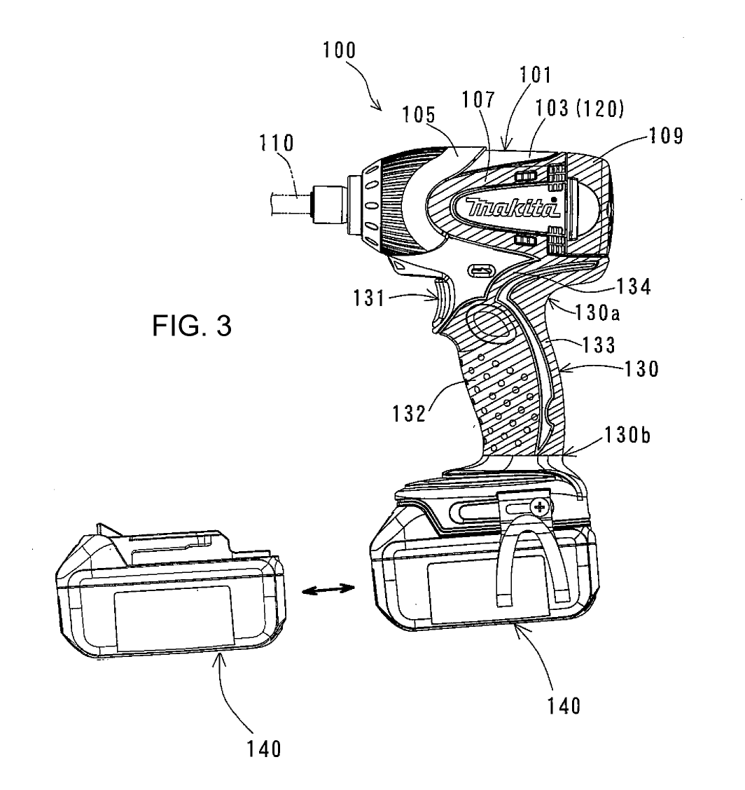

FIG. 3 shows the battery 140 of the impact driver 100 shown in FIG. 1 in the attached state and in the detached state. As shown in FIG. 3, the housing of the cylindrical cells of the battery 140 does not protrude upward from the upper surface of the battery in part or in entirety. Thus, in the battery attached state, the housing of the cylindrical cells is placed outside the grip region below the grip distal end 130b. In other words, the housing of the cylindrical cells is not housed within the accommodating space of the handgrip 130. This construction is thus different from a battery of so-called plug-in type in which the housing of the cylindrical cells protrudes upward from the upper surface of the battery and in which the housing of the cylindrical cells is housed in part or in entirety within the accommodating space of the handgrip in the battery attached state. Specifically, the housing of the cylindrical cells of the battery 140 is placed outside the grip region, and the battery 140 is configured as a so-called slide-type, in which the battery attaching/detaching operation is performed by sliding the battery. Therefore, the battery 140 can be detached by sliding the battery 140 from the attached position in the sliding direction (the direction that crosses the axial direction of the driver bit 110). The battery 140 detached from the handgrip 130 can be recharged by connecting to a battery charger (not particularly shown).

In the impact driver 100 having the above-mentioned construction, when the user holds the handgrip 130 and depresses the trigger 131 to throw a power switch, the driving motor 120 is driven. The driver bit 110 is then rotated via the speed reducing mechanism, the spindle, the hammer and the anvil and performs a screw-tightening operation. The operating principle of the impact driver 100 is known in the art and therefore will not be described in detail.

Operations using the impact driver 100 include the manner of operating while pressing the horizontally extending driver bit 110 forward, the manner of operating while pressing the vertically extending driver bit 110 upward or downward, and the manner of operating while pressing the obliquely extending driver bit 110 upward or downward.

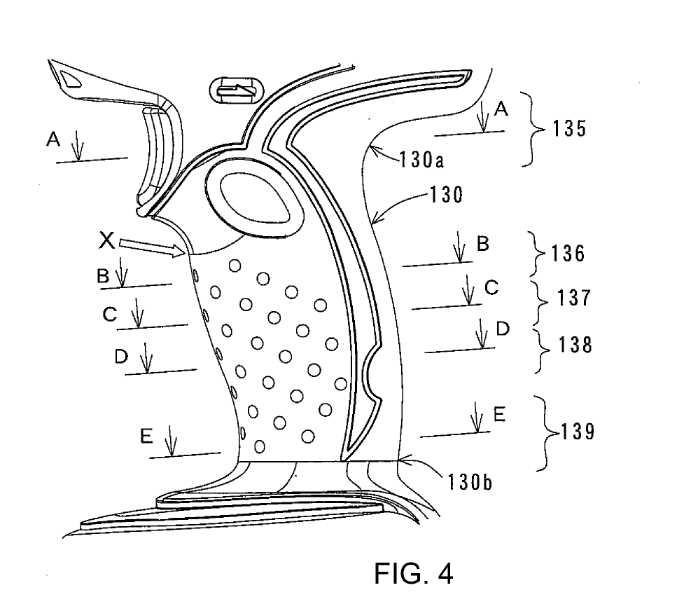

Next, the construction and operation of the handgrip 130 of this embodiment will now be explained in detail with reference to FIGS. 4 to 12.

In this embodiment with the slide-type battery 140 as mentioned above, the size of the accommodating space within the handgrip 130 is not restricted by the housing of the cylindrical cells of the battery 140. Therefore, this construction is advantageous in increasing the degree of freedom of design with respect to the configuration of the handgrip 130. In a power tool which is designed to have a plug-in type removable battery, the configuration of the housing of the cylindrical cells housed within the accommodating space of the handgrip influences the configuration of the handgrip. However, with the construction in which a slide-type battery is used like in this embodiment, the configuration of the housing of the cylindrical cells does not influence the configuration of the handgrip, so that the degree of freedom of design with respect to the configuration of the handgrip can be increased.

FIG. 4 shows the handgrip 130 in side view. In the handgrip 130 of FIG. 4, a first grip region 135 is defined as a region in which a web part between the thumb and the forefinger is positioned when holding the handgrip. A second grip region 136 is defined as a region in which the middle finger is positioned when holding the handgrip. A third grip region 137 is defined as an intermediate region in which the middle finger or the third finger is positioned when holding the handgrip. A fourth grip region 138 is defined as a region in which the third finger is positioned when holding the handgrip. A fifth grip region 139 is defined as a region in which the little finger is positioned when holding the handgrip. Particularly, the second to fifth grip regions 136-139 are arranged, for example, within the range of 47.0 mm±2% from the grip distal end 130b toward the grip proximal end 130a.

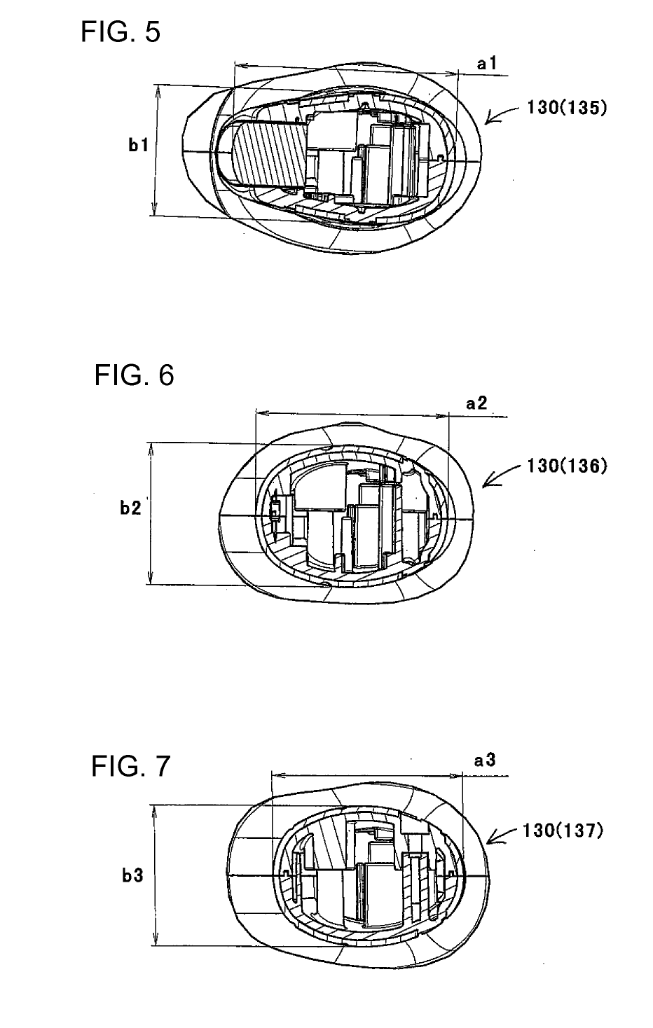

With respect to the sectional configuration of the handgrip 130 of FIG. 4, FIGS. 5 to 9 shows the sectional views taken along line A-A, line B-B, line C-C, line D-D and line E-E in FIG. 4, respectively. In this embodiment, these cross sections are taken along the direction in which the battery 140 extends lengthwise.

As shown in FIG. 5, the cross section of the handgrip 130 in the first grip region 135 is configured to be oval. For example, a major axis a1 is defined within the range of 53.6 mm±2% in the fore-and-aft direction of the handgrip, and a minor axis b1 is defined within the range of 31.2 mm±2% in the sidewise direction of the handgrip.

As shown in FIG. 6, the cross section of the handgrip 130 in the second grip region 136 is configured to be oval. For example, a major axis a2 is defined within the range of 46.0 mm±2% in the fore-and-aft direction of the handgrip, and a minor axis b2 is defined within the range of 34.5 mm±2% in the sidewise direction of the handgrip.

As shown in FIG. 7, the cross section of the handgrip 130 in the third grip region 137 is configured to be oval. For example, a major axis a3 is defined within the range of 45.4 mm±2% in the fore-and-aft direction of the handgrip, and a minor axis b3 is defined within the range of 33.7 mm±2% in the sidewise direction of the handgrip.

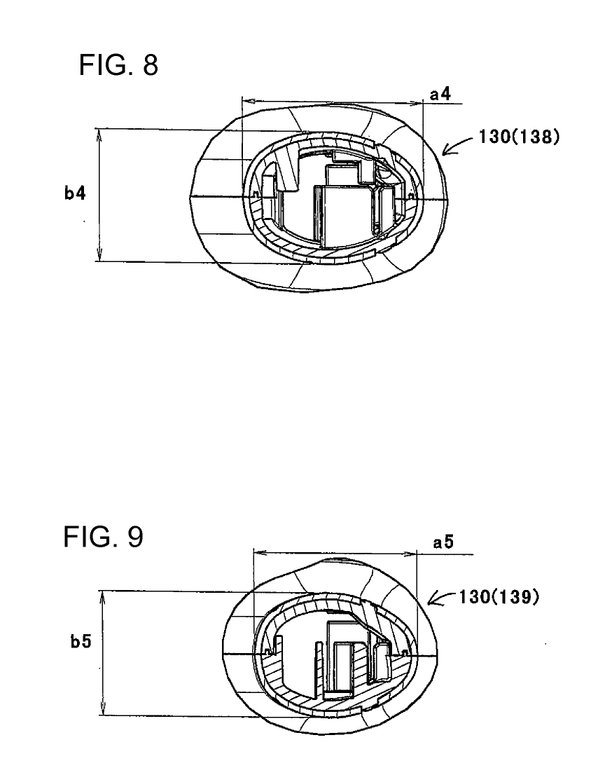

As shown in FIG. 8, the cross section of the handgrip 130 in the fourth grip region 138 is configured to be oval. For example, a major axis a4 is defined within the range of 43.3 mm±2% in the fore-and-aft direction of the handgrip, and a minor axis b4 is defined within the range of 32.0 mm±2% in the sidewise direction of the handgrip.

As shown in FIG. 9, the cross section of the handgrip 130 in the fifth grip region 139 is configured to be oval. For example, a major axis a5 is defined within the range of 38.7 mm±2% in the fore-and-aft direction of the handgrip, and a minor axis b5 is defined within the range of 29.4 mm±2% in the sidewise direction of the handgrip.

As shown in FIGS. 6 to 9, the grip diameter (major and minor axes) is at the maximum in the second and third grip regions 136 and 137 within the range between the second grip region 136 and the grip distal end. The grip diameter (major and minor axes) of the handgrip 130 is gradually reduced toward the grip distal end 130b and to a minimum in the fifth grip region 139. Although not shown, substantially like the grip diameter (major and minor axes), the cross-sectional area and the perimeter of the handgrip are at the maximum in the second and third grip regions 136 and 137 and gradually reduced toward the grip distal end 130b and to a minimum in the fifth grip region 139.

Although, in this embodiment, the grip diameter (major and minor axes) of the handgrip is described with respect to the cross sections extending along the longitudinal direction of the battery as an example, the grip diameter (major and minor axes) of each part of the handgrip can be appropriately defined in consideration of the position and orientation of the cross sections, errors and tolerances.

When the user holds the handgrip, if the little finger can securely grip the handgrip, the holding force of the entire palm can be effectively utilized. With consideration given to this fact, the handgrip is configured such that the grip size (at least the grip diameter) is at the maximum in the region which is held by the middle finger or the third finger and at the minimum in the region which is held by the little finger. The second or the third grip region 136 or 137 in this case is a feature that corresponds to the “maximum diameter portion”, and the fifth grip region 139 to the “minimum diameter portion” according the invention. Further, the position of the maximum diameter portion (the region in which the grip diameter is maximum) may substantially coincide like in this embodiment, or may not necessarily coincide with the position of the maximum cross-section portion (the region in which the cross-sectional area is maximum) or the position of the maximum perimeter portion (the region in which the grip perimeter is maximum). Likewise, the position of the minimum diameter portion (the region in which the grip diameter is minimum) may substantially coincide, or may not necessarily coincide with the position of the minimum cross-section portion (the region in which the cross-sectional area is minimum) or the position of the minimum perimeter portion (the region in which the grip perimeter is minimum).

Further, although a sectional configuration is not shown, a region X (shown in FIG. 4) nearer to the grip proximal end 130a than the second grip region 136 is configured to have a smaller grip diameter, a smaller perimeter and a smaller cross-sectional area than the second grip region 136. The portion on which the holding force of the hand is substantially exerted when the user holds the power toeol by hand, is first thinner on the side of the grip proximal end 130a and gets thicker and then thinner again toward the grip distal end 130b.

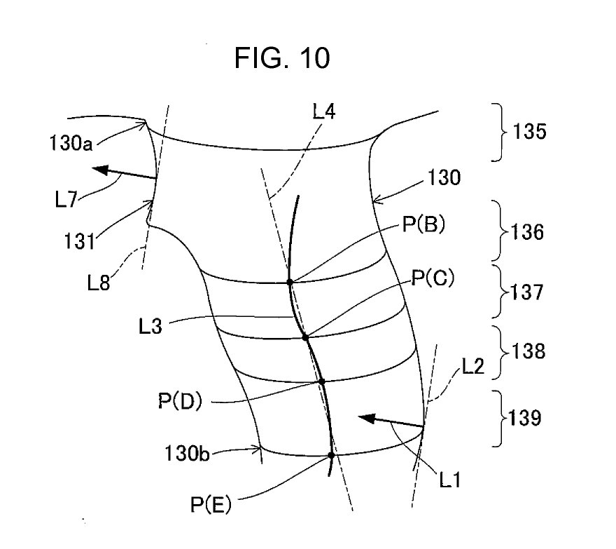

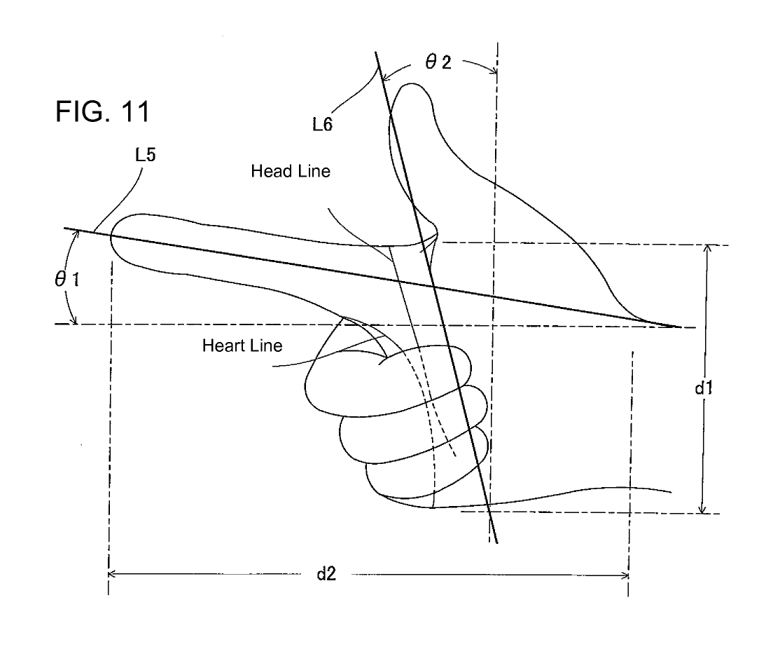

FIG. 10 schematically shows the surface configuration of the handgrip 130 according to the embodiment. The handgrip 130 shown in FIG. 10 is configured such that a normal L1 on the rear end surface of the region of the grip distal end 130b (a line perpendicular to a tangent L2 on the rear end surface) crosses the axis of the driver bit 110 forward of the handgrip. In other words, the normal L1 that extends upward to the left as viewed in FIG. 10 in a straight line crosses the axis (not shown) of the substantially horizontally extending driver bit 110 forward of the handgrip. A normal like the normal L1 which crosses the axis of the driver bit 110 forward of the handgrip may be formed in at least one point in the grip distal end region. For example, a normal may be formed only on the grip distal end 130b. Otherwise, a plurality of normals may be formed within a predetermined region between the grip distal end 130b and the grip proximal end 130a. In this embodiment, the normal L1 is arranged based on the “human body data analysis” which will be described below.

Further, in the handgrip 130 as shown in FIG. 10, a line that continuously and vertically connects vertexes on the grip side surface, or a connecting line that continuously connects, for example, a vertex P (B) in the second grip region 136, a vertex P (C) in the third grip region 137, a vertex P (D) in the fourth grip region 138 and a vertex P (E) in the fifth grip region 139 forms a curved line L3. As shown in FIG. 10, the curved line L3 extends in the form of a letter S such that the upper end of the line is directed toward the rear end of the grip proximal end 130a and the lowser end of the line is directed toward the front end of the grip distal end 130b. In this case, when the connecting line that connects vertexes on one side surface of the grip extends in the form of a letter S, another connecting line that connects vertexes on the other side surface of the grip is a mirror image of said connecting line (in the form of a letter S). The curved line L3 is a feature that corresponds to the “connecting line” in this invention. In this embodiment, the curved line L3 or an extending line L4 that extends along the curved line L3 is arranged based on the “human body data analysis” which will be described below.

Further, the handgrip 130 shown in FIG. 10 is configured such that a normal L7 on the front surface of the trigger 131 (a line perpendicular to a tangent L8 on the trigger front surface) crosses the axis of the driver bit 110 forward of the handgrip. In other words, the normal L7 that extends upward to the left as viewed in FIG. 10 in a straight line crosses the axis (not shown) of the substantially horizontally extending driver bit 110 forward of the handgrip. The front surface of the trigger 131 comprises a contact region depressed in contact with the forefinger of the user. A normal like the normal L7 which crosses the axis of the driver bit 110 forward of the handgrip may be formed in one or more points on the trigger front surface. In this embodiment, the normal L7 is arranged based on the “human body data analysis” which will be described below.

The configuration of the handgrip 130 is designed based on a human body data analysis, a sensory evaluation analysis and a mechanical simulation analysis which will be described below. Particularly, as a result of verification by evaluation using the mechanical simulation analysis and sensory evaluation analysis, representative handgrip 130 reduces the load on the fingers of the user and easily enables loan hours operation.

In order to examine the form of the fingers and palm of the user who are holding the handgrip, sampling of the form of the fingers and palm was conducted on 30 Japanese adult men ages 20 to 40. As shown in FIG. 11, a vertical distance d1 from the underside of the hand to the web part averaged 82 mm and a horizontal distance d2 from the base of the hand to the forefinger averaged 181 mm. Further, an extending angle θ1 of an extending line L5 that extends along the straightened forefinger with respect to a horizontal line averaged 10°, and an extending angle θ2 of an extending line L6 along which a hollow (concave portion) of the palm extends vertically with respect to a vertical line averaged 15°. The palm-related extending line L6 can be defined as a line that extends substantially along the heart line or the head line on the palm.

In this embodiment, the handgrip is configured such that the above-mentioned normal L1 (related to the grip configuration) on the grip rear end surface extends along the palm-related extending line L5. With this configuration, the pressing force exerted on the rear end surface of the handgrip 130 is allowed to act evenly upon the entirety of the handgrip 130.

Further, in this embodiment, the handgrip is configured such that the above-mentioned extending line L4 or the curved line L3 (related to the grip configuration) on the grip side surface extends along the palm-related extending line L6. In other words, considering the fact that a hollow (concave portion) is formed in the grip holding palm particularly along the heart line and the head line, the handgrip is configured such that the vertexes (convex portions) of the grip side surface extend along this hollow of the palm and are fitted into the hollow (concave portion). With this configuration, the user can hold the handgrip evenly with the entire palm.

Further, in this embodiment, the handgrip is configured such that the above-mentioned normal L7 (related to the grip configuration) on the trigger front surface extends along the palm-related extending line L5. In other words, the position and orientation of the trigger 131 are defined based on the extending angle θ1 shown in FIG. 11 so that the user can easily depress the trigger 131 with the forefinger and can easily exert the force of the forefinger on the trigger.

A sensory evaluation analysis was conducted on the handgrip 130 as well as various known handgrips by questionnaires to sampling subjects who were chosen like in the case of the above-mentioned human body data analysis. The questionnaires were made on the feels of hold which they had (whether it fits or conforms well) by actually holding the handgrip. The results showed that the sampling subjects preferred the handgrips according to the representative embodiment that is configured to have a substantially thin grip diameter over its entirety, and configured such that the grip diameter is gradually reduced from the portion for the middle finger toward the portion for the little finger via the portion for the third finger, and also configured such that the entire palm evenly contacts the surface of the handgrip.

Further, a mechanical simulation analysis was conducted on the handgrip 130 of this embodiment and comparative examples. In this analysis, the grasping power distribution on the handgrip surface of each of the handgrips was obtained, and pressure and skin shearing stress on each part of the fingers and palm (the web part, the part from the forefinger to the little finger, and the palm) were calculated based on the grasping power distribution. As a result, by using the handgrip 130 of this embodiment, it was made possible to realize favorable values as to the pressure and skin shearing stress on each part of the fingers and palm.

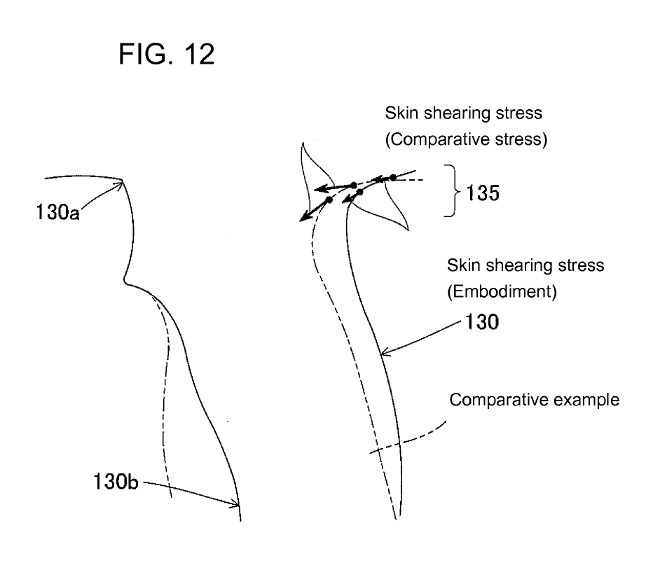

In this connection, FIG. 12 shows the distribution of skin shearing stress on the web part as a result of the mechanical simulation analysis on the handgrip 130 according to the representative embodiment and a comparative example. A handgrip having a configuration as shown by phantom line in FIG. 12 was used as the comparative example. As shown in FIG. 12, the skin shearing stress of the fingers and palm on a handgrip is remarkably reduced by use of the handgrip of the embodiment compared with the comparative example. Thus, the representative handgrip of the embodiment may have a configuration which can prevent the user from suffering pains in the web part.

As mentioned above, the handgrip 130 can take some of the load off the fingers of the user. Thus, the handgrip configuration can be realized which is easy to hold, offers less user fatigue and causes less pain in the user's hand (particularly in the web part) during operation.

Specifically, with the construction in which the normal L1 on the rear end surface of the region of the grip distal end 130b crosses the axis of the driver bit 110 forward of the handgrip, the pressing force exerted on the rear end surface of the handgrip 130 is allowed to act evenly upon the entirety of the handgrip 130 when the user performs an operation while moving the grip holding hand forward of the power tool. Thus, the user can perform an operation while evenly pressing the handgrip 130 in the hand toward the tip end of the tool. Therefore, the handgrip configuration which offers less fatigue and causes less pain in the user's hand during operation can be realized. Particularly with the construction in which the normal L1 extends along the palm-related extending line L5, the handgrip configuration can be realized in which the pressing force of the user pressing the handgrip 130 in the hand is readily transmitted to the axis of the driver bit 110. Such a configuration of the handgrip 130 is particularly advantageous in the power tools with which the user may perform long hours of operation while pressing the tool bit in various directions.

Further, according to the representative embodiment, the grip dimensions (grip diameter, grip cross-sectional area, grip perimeter) are gradually reduced, from the region to which the middle finger or the third finger is assigned, toward the grip distal end region and are minimized particularly in the region to which the little finger is assigned. With this configuration, the holding force of the entire palm can be effectively utilized. As to the grip dimensions (grip diameter, grip cross-sectional area, grip perimeter), optimum values can be selected according to variations in size of the fingers and palm by race, sex or age. For example, handgrips designed specifically for Europeans and Americans can be scaled up in the grip dimensions (grip diameter, grip cross-sectional area, grip perimeter) to about 106 to 110% or preferably about 108% of those designed for Orientals, while maintaining the grip basic performance.

Further, with the configuration in which the line continuously and vertically connecting vertexes on the grip side surface forms the curved line L3 that extends in the form of a letter S substantially along the heart line or the head line of the grip holding palm, the vertexes (convex portions) of the grip side surface are snugly fitted into the hollow (concave portion) of the palm, so that the handgrip having an excellent fit can be realized.

Further, in this embodiment, with the configuration in which the normal L7 on the front surface of the trigger 131 extends along a direction in which the forefinger extends when straightened from its grip holding position, the user can easily depress the trigger 131 with the forefinger and can easily exert the force of the forefinger on the trigger.

Further, by using the battery 140 of which cylindrical cell housing is placed outside the grip region, the degree of freedom of design with respect to the configuration of the handgrip 130 can be increased. This is effective in realizing a handgrip which is advantageously configured to save the load on the user's fingers.

This invention is not limited to the impact driver 100, but can be applied to various other power tools which are used for cutting, grinding, polishing, nailing, riveting or drilling. At this time, as for the tool bit driving methods, it may be configured such that the tool bit is driven by a driving motor which is powered through an AC power or a battery, or driven by air or gas pressure.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

### DESCRIPTION OF NUMERALS

100 impact driver (power tool)
101 body
103 motor housing
105 gear housing
107 side contact portion
109 rear end contact portion
110 driver bit (tool bit)
120 driving motor
130 handgrip
130a grip proximal end
130b grip distal end
131 trigger
132 grip front contact portion
133 grip rear contact portion
134 connecting portion
135 first grip region
136 second grip region
137 third grip region
138 fourth grip region
139 fifth grip region
140 battery

What we claim is:

1. A power tool, comprising:
a body,
a tool bit mounted to a tip end region of the body,
a driving mechanism housed within the body to drive the tool bit,
a handgrip that extends from a grip proximal end on the side of the body to a grip distal end in a direction that crosses the axial direction of the tool bit and
a holding optimization region that optimizes the force of the palm and fingers of the user on the handgrip, the holding optimization region being arranged on the handgrip and shaped to match with a holding form of the fingers of the user when the user holds the handgrip.

2. The power tool as defined in claim 1, wherein, on the rear end surface of the grip distal end region, the holding optimization region includes a region configured such that a normal on the rear end surface crosses an axis of the tool bit forward of the handgrip and
wherein, when the user performs an operation while pressing the power tool forward by hand, the direction of the pressing force applied from the palm to the rear end surface of the handgrip substantially coincides in said region with the direction of the normal on the rear end surface, whereby the pressing force of the user's hand is evenly exerted on the handgrip.

3. The power tool as defined in claim 2, wherein the handgrip is configured such that said normal extends along a direction in which the forefinger extends when straightened from the grip holding position.

4. The power tool as defined in claim 1, further comprising:
a trigger provided on a front portion of the handgrip and operated to start and stop the driving means and
a trigger front surface that is provided on the trigger and depressed by the user with the thick of the forefinger, wherein, on the trigger front surface, the holding optimization region includes a region configured such that a normal on the trigger front surface crosses an axis of the tool bit forward of the handgrip, and wherein, when the user performs an operation by depressing the trigger with the forefinger while holding the handgrip, the direction of depressing the trigger by the forefinger substantially coincides in said region with the direction of the normal on the trigger front surface, whereby the force of the user's fingers on the handgrip is optimized.

5. The power tool as defined in claim 1, wherein, in the handgrip, the holding optimization region includes a region configured such that the handgrip has an oval section along the axial direction of the tool bit and such that said section has a maximum diameter portion of which both major axis and minor axis are maximum and a minimum diameter portion of which both major axis and minor axis are minimum, the maximum diameter portion being disposed between the grip proximal end and the grip distal end of the handgrip, the minimum diameter portion being disposed nearer to the grip distal end than the maximum diameter portion, and wherein the holding optimization region is configured such that a finger on the grip distal end side is able to grip the handgrip more securely than a finger on the grip proximal end side when the user performs an operation while holding the handgrip, whereby the pressing force of the user's hand is evenly exerted on the handgrip.

6. The power tool as defined in claim 5, wherein handgrips designed specifically for relatively big users are scaled up in the major and minor axes of the maximum and minimum diameter portions to about 106 to 110% or preferably about 108% of handgrips designed for relatively small users.

7. The power tool as defined in claim 5, wherein, in the handgrip, the holding optimization region is configured such that the maximum diameter portion is formed in a region in which the middle finger or the third finger is positioned when holding the handgrip and the minimum diameter portion is formed in a region in which the little finger is positioned when holding the handgrip.

8. The power tool as defined in claim 1, wherein, in the handgrip, the holding optimization region includes a region configured such that a connecting line that continuously and vertically connects vertexes on a side surface of the handgrip extends in the form of a letter S such that an upper end of the line is directed toward a rear end of the grip proximal end and a lower end of the line is directed toward a front end of the grip distal end, and wherein the vertexes of the handgrip side surface are snugly fitted into a concave portion formed in the user's palm when the user performs an operation while holding the handgrip, whereby the pressing force of the user's hand is evenly exerted on the handgrip.

9. The power tool as defined in claim 8, wherein the handgrip is configured such that the connecting line extends substantially along a heart line or a head line of the palm of the user who is holding the handgrip.

10. The power tool as defined in claim 1, further comprising a trigger that is provided on a front portion of the handgrip and operated to start and stop the driving means, and a trigger front surface that is provided on the trigger and depressed by the user with the thick of the forefinger, wherein the holding optimization region includes at least one of a first to a fourth regions,
the first region being configured on the rear end surface of the grip distal end region such that a normal on the rear end surface crosses an axis of the tool bit forward of the handgrip,
the second region being configured on the trigger front surface such that a normal on the trigger front surface crosses an axis of the tool bit forward of the handgrip,
the third region being configured in the handgrip such that the handgrip has an oval section along the axial direction of the tool bit and has a maximum diameter portion of which both major axis and minor axis in said section are maximum and a minimum diameter portion of which both major axis and minor axis in said section are minimum, the maximum diameter portion being disposed in a region of the handgrip between the grip proximal end and the grip distal end, the minimum diameter portion being disposed nearer to the grip distal end than the maximum diameter portion, and
the fourth region being configured in the handgrip such that a connecting line that continuously and vertically connects vertexes on a side surface of the handgrip extends in the form of a letter S such that an upper end of the line is directed toward a rear end of the grip proximal end and a lower end of the line is directed toward a front end of the grip distal end,
whereby the pressing force of the user's hand is evenly exerted on the handgrip.

11. The power tool as defined in claim 1, further comprising an electric motor as the driving member and a battery removably attached to the grip distal end portion of the handgrip to supply current to the electric motor, wherein the battery has a housing that houses one or more cylindrical cells and the housing is placed outside a grip region below the grip distal end when the battery is in an attached state.
